(19) United States
(12) Patent Application Publication
(10) Pub. No.: US 2014/0097374 A1
(43) Pub. Date: Apr. 10, 2014

(54) EXCESS FLOW VALVE WITH FLEXIBLE DIAPHRAGM MEMBER

(71) Applicant: Hyun Moon, Bloomfield Hills, MI (US)

(72) Inventor: Hyun Moon, Bloomfield Hills, MI (US)

(73) Assignee: BRASSCRAFT MANUFACTURING COMPANY, Novi, MI (US)

(21) Appl. No.: 13/647,542

(22) Filed: Oct. 9, 2012

(51) Int. Cl. F16K 1/42; B21D 51/00

(52) U.S. Cl. 251/359; 29/890.12

(57) ABSTRACT

An assembly for limiting excess flow includes a seat and a disc. The seat has an inner ring, an outer ring having a top surface tapering in a downstream direction from outer ring towards the inner ring, and a plurality of legs attaching the inner ring to the outer ring. The disc attaches to the inner ring and extends radially outwardly therefrom. The disk has an axially downstream surface that flexes into contact with the outer ring if the flow exceeds a limit around the disc, and a shoulder spacing the axially downstream surface from the inner ring to space the disc axially from the outer ring.

### BACKGROUND OF THE INVENTION

The present invention generally relates to an excess flow check valve that permits fluid flow through a flow line if the flow is below a predetermined flow rate but minimizes the flow line if the flow rate rises above the predetermined limit to prevent uncontrolled flow or discharge of fluids.

### SUMMARY OF THE INVENTION

Excess flow valves are typically used in a capsule to facilitate its installation in various flow lines, fittings, pipe systems, appliances and the like. The excess flow valve acts in response to a high or a low differential pressure between the upstream pressure and downstream pressure of the capsule. The capsule usually has four portions comprising a seat, a housing, a valve plate or body, and a spring or magnet to bias the valve plate. The capsule may be inserted in various flow passageways including a valve body, a connector fitting, a hose fitting, a pipe nipple, a tube, an appliance and other similar installations to provide excess flow protection.

A capsule facilitates assembly of the individual components into a self-contained compact package, provides for easy insertion of the capsule into a fitting or tube, provides a substantial restriction, provides a small leakage flow for automatic valve resetting, precisely positions and retains the components of the valve for proper operation, provides a unique structure for coupling the two capsule components, permits flow testing as a capsule to verify performance, and provides a compact configuration to minimize the size, diameter and length required to accommodate the capsule.

According to an embodiment described herein, an assembly for limiting excess flow includes a seat and a disc. The seat has an inner ring, an outer ring having a top surface tapering in a downstream direction from outer ring towards the inner ring, and a plurality of legs attaching the inner ring to the outer ring. The disc attaches to the inner ring and extends radially outwardly therefrom. The disk has an axially downstream surface that flexes into contact with the outer ring if the flow exceeds a limit around the disc, and a shoulder spacing the axially downstream surface from the inner ring to space the disc axially from the outer ring.

According to an embodiment described herein, a method of creating an assembly for limiting excess flow includes the steps of: providing a seat, the seat having an inner ring, an outer ring having a top surface from outer ring towards the inner ring, and a plurality of legs attaching the inner ring to the outer ring, selecting a taper angle of the outer ring in a downstream direction from an outer periphery thereof, and providing a flexible disc attaching to the inner ring and extending radially outwardly therefrom, the disk having a axially downstream surface that flexes into contact with the outer ring if the flow exceeds a limit around the disc, and providing a shoulder spacing the axially downstream surface from the inner ring to space the disc axially from the outer ring.

These and other features of the present invention can be best understood from the following specification and drawings, the following of which is a brief description.

### BRIEF DESCRIPTION OF THE DRAWINGS

FIG. 1 shows a gas coupling pipe including an excess flow assembly.

FIG. 2 shows a first embodiment of an excess flow assembly used in the pipe of FIG. 1 in a first position and a second condition.

FIG. 3 shows the unassembled excess flow assembly shown in FIG. 2.

FIG. 4 shows a taper angle from an outer ring to an inner ring.

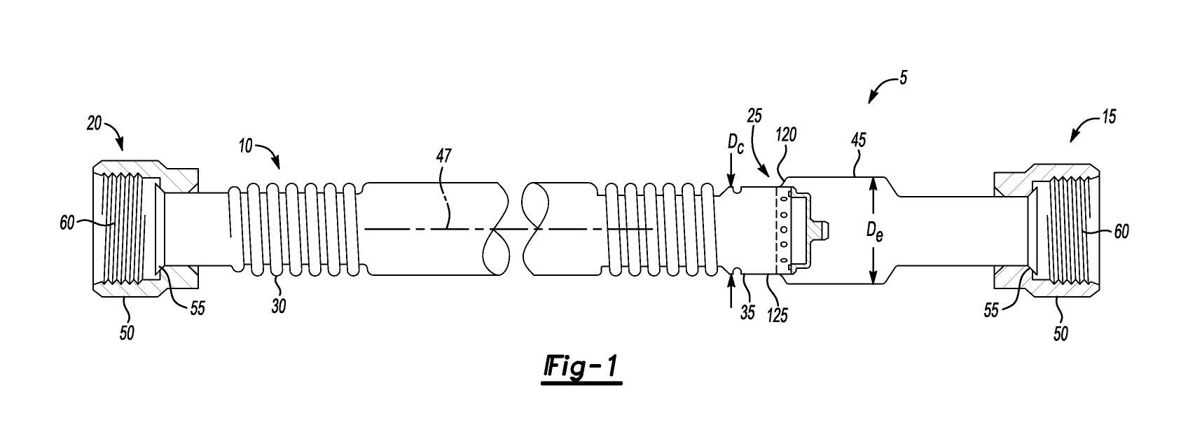

### DETAILED DESCRIPTION OF THE PREFERRED EMBODIMENT

Referring now to the Figures, gas connector 5 includes a fluid pipe 10 having an inlet coupling 15, an outlet coupling 20, and an excess flow assembly 25. The pipe may carry different fluids, such as natural gas, or other gases or liquids. The assembly 25 is molded or cast as separate pieces. Fluid flows in the direction F through the excess flow assembly 25. The pipe 10 extends along an axis 47.

The pipe 10, which may have corrugations 30, has a non-corrugated area 35 that holds the assembly 25, which is bounded by a radially inwardly depending shoulder 40, which may be a groove, and an expanded area 45 for interacting with the excess flow assembly 25 as will be discussed infra.

The expanded area 45 has an increased diameter Dₑ relative to the diameter D_{c} of the non-corrugated area 35 to provide more area for fluid flow around and through the assembly 25.

The inlet coupling 15 and the outlet coupling 20 each have a housing 50 that surrounds flared ends 55, as are known in the art, of the pipe 10. The housings 50 each have an internal thread 60 for mating with external threads (not shown) of a gas supply line (not shown) at the inlet coupling 15 and with the external threads (not shown) of an appliance (not shown) at the outlet coupling 20.

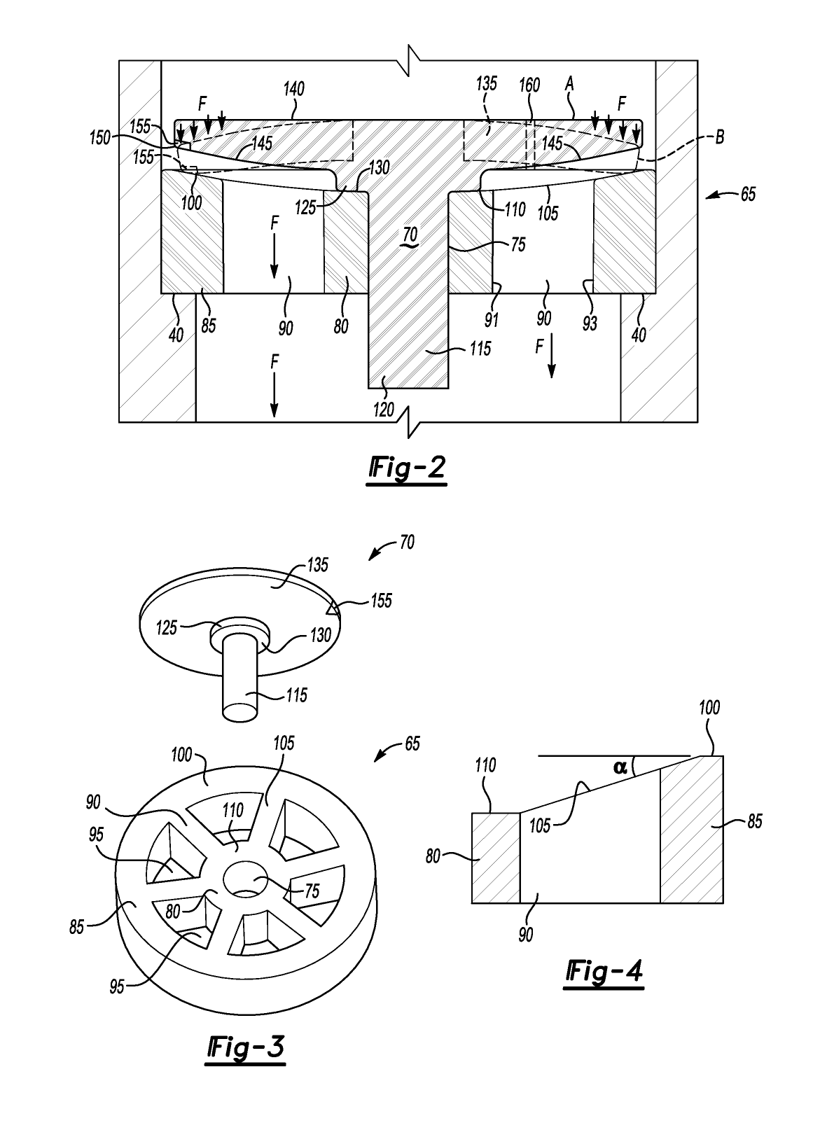

Referring now to FIGS. 2 and 3, the two-piece assembly 25 has two basic components, a valve seat 65, and a flexible umbrella 70. The umbrella 70 is made of a flexible, fluid resistant material such as rubber or silicone or the like. The valve seat 65 may be made of a stiffer fluid resistant material, like plastic, or the like. The assembly 25 may also be made in one piece by using a co-injection process where one of the valve seat 65, and the flexible umbrella 70 are molded first and the other of the valve seat 65 and the flexible umbrella 70 are molded atop, or into, the other of the valve seat 65 and the flexible umbrella 70. The stiffness of the umbrella 70 may be adjusted for differing applications depending on flow rates required in a particular application.

The valve seat 65, which is generally cylindrical, has a centrally disposed passageway 75 for receiving the umbrella 70, an inner ring 80, an outer ring 85 and a plurality of legs 90 connecting an outer periphery 91 of the inner ring to an inner periphery 93 of the outer ring 85. The outer ring 85 has an interference fit within the non-corrugated area 35 so that fluid does not escape around the outer ring 85. The legs 90 define fluid flow areas 95 therebetween such that fluid may flow about the umbrella 70 during normal operation and through the fluid flow areas 95. A top surface 100 of the outer ring 85 and a top surface 105 of the legs 90 taper axially downstream from the outer ring 85 to the inner ring 80. A top surface 110 of the inner ring 80 may also taper. The angle a of the taper depends on required flow rates in a particular application. As an angle of the taper increases axially downstream, the amount of flow through the assembly 25 may increase.

The umbrella 70 has a central shaft 115 that extends through the passageway 75. The umbrella 70 acts as a valve. The central shaft 115 may be anchored within the passageway 75 by gluing, sonic welding, by an expanded area 120 that is press fit in the passageway 75, or the like. The shaft has a spacing portion 125 having a bottom surface 130 that sits on the top surface 110 of the inner ring 80. As with the taper angle a, the length of the spacing portion creates space between the umbrella and the valve seat 65 to measure flow at the appropriate amount. A disc 135 extends concentrically and axially upstream from the central shaft 115. The disc 135 has a flat upstream surface 140 and a curved or tapered (i.e. shaped) downstream portion 145 that mates with the taper of the top surface 100 of the outer ring 85 as will be discussed infra. The curved downstream portion 145 extends from the spacing portion 125 to a peripheral edge 150.

A notch 155 may be cut in the disc 135 to allow the assembly 25 to reset itself if an excess flow condition no longer exists as is known in the art. The disc 135 may also have a pin-hole 160 cut through it for the same purpose.

During normal operation in which there is no excess flow, fluid such as natural gas, flows through the pipe 10, around the disc 135, between the legs 90 and through the flow fluid flow areas 90. Because the expanded area 45 increases the area of flow of gas around the assembly 25, and because there is room around the disc 135 because of the height of the spacing portion 125, there is relatively little pressure drop as the fluid flows by the disc 135. The disc 135, therefore, does not flex and stays in position A shown by the solid lines in FIG. 2.

If there is a breakage or the like in the pipe 10, fluid flow through the assembly 25 may not be limited by an appliance (not shown) and there is a risk that fluid may flow above a given limit without obstruction. The pressure drop upstream and downstream of the assembly 25 increases greatly due to the increased flow and the disc 135 flexes and is induced towards the valve seat 65 to seat against the top surface 100, 105 of the outer ring 85 and legs 90 in position B (see the dotted lines in FIG. 2). The curved downstream portion 145 mates with the taper of the top surface 105.

Fluid may leak through the notch 155 or the pinhole 160 to allow pressure to equalize upstream and downstream of the disc 135. After the pressure is equalized, such as if the pipe 10 is fixed, the flexibility of the umbrella 70 allows the valve plate to return to position A, thereby allowing gas to flow through the cartridge 25.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1. An assembly for limiting excess flow, the assembly comprising:
a seat having an inner ring, an outer ring having a top surface tapering in a downstream direction from the outer ring towards the inner ring, and a plurality of legs attaching the inner ring to the outer ring, and
a disc attaching to the inner ring and extending radially outwardly therefrom, the disk having an axially downstream surface that flexes into contact with the outer ring if the flow exceeds a limit around the disc and a shoulder spacing the axially downstream surface from the inner ring to space the disc axially from the outer ring.

2. The assembly of claim 1 wherein the legs attach to a radial inner periphery of the outer ring and a radial outer periphery of the inner ring.

3. The assembly of claim 1 wherein the disc has a curved surface that is spaced apart from the top surface of the outer ring when the flow does not exceed the limit and wherein the curved surface mates with the top surface of the outer ring if the flow exceeds a limit.

4. The valve of claim 1 wherein the outer ring has a tapered portion at a taper angle alignment with a shaped portion of the disc.

5. The assembly of claim 4 wherein a top portion of each leg is tapered to match the taper angle of the tapered portion.

6. The assembly of claim 5 wherein the disc has a curved surface flexes axially downstream if the limit is exceeded.

7. The assembly of claim 1 wherein the disc is flat across its upstream portion if the limit is not exceeded.

8. The assembly of claim 1 wherein fluid does not flow through a center of the disc.

9. The assembly of claim 1 wherein a normal flow passes around the disk and then through the seat and the flow is minimized around the disk and then through the seat if the limit is exceeded.

10. The assembly of claim 1 wherein the top surface of the outer ring is tapered but has no grooves.

11. The assembly of claim 1 wherein the legs taper in a downstream direction from the outer ring to the inner ring

12. A method of creating an assembly for limiting excess flow, the method comprising:
providing a seat, the seat having an inner ring, an outer ring having a top surface from the outer ring towards the inner ring, and a plurality of legs attaching the inner ring to the outer ring, selecting a taper angle of the outer ring in a downstream direction from an outer periphery thereof,
providing a flexible disc attaching to the inner ring and extending radially outwardly therefrom, the disk having an axially downstream surface that flexes into contact with the outer ring if the flow exceeds a limit around the disc, and
providing a shoulder spacing the axially downstream surface from the inner ring to space the disc axially from the outer ring.

13. The method of claim 12 further comprising the step of:
forming the shoulder to sit on a top surface of the inner ring and selecting a height of the shoulder to space the disc from the outer ring and determine an allowable flow rate therethrough.

14. The method of claim 12 further comprising the step of:
selecting a stiffness of the disc to determine an allowable flow rate therethrough.

15. The method of claim 12 further comprising the step of:
fixing the seat in a first portion of a pipe having a first diameter, and positioning the flexible disc within the pipe in a second portion having a second diameter that is greater than the first diameter.

16. The method of claim 12 further comprising the step of:
providing the flexible disc with a flat upstream surface and a non-flat downstream surface when the flexible disc is spaced from contact with the seat.

17. The method of claim 16 further comprising the step of:
providing the non-flat surface as one of a tapered or curved surface.

18. The method of claim 12 further comprising the steps of:
mounting the seat and flexible disc within a pipe having an upstream end configured for attachment to an inlet coupling and a downstream end configured for attachment to an outlet coupling, the pipe defining a gas pathway from the inlet coupling to the outlet coupling; and
fixing a shaft extending from the flexible disc to the inner ring.

19. The assembly of claim 1 wherein the seat and flexible disc are mounted within a pipe having an upstream end configured for attachment to an inlet coupling and a downstream end configured for attachment to an outlet coupling, the pipe defining a gas pathway from the inlet coupling to the outlet coupling, and including a shaft extending from the disc wherein the shaft is fixed to the inner ring.

20. The assembly of claim 1 wherein the seat is fixed in a first portion of a pipe having a first diameter, and wherein the disc is positioned within the pipe in a second portion having a second diameter that is greater than the first diameter.

21. The assembly of claim 1 wherein the disc includes a flat upstream surface and wherein the axially downstream surface comprises a non-flat downstream surface when the disc is spaced from contact with the seat.

22. The assembly of claim 21 wherein the non-flat surface is one of a tapered or curved surface.

23. The assembly of claim 1 wherein the legs include a top surface extending from the top surface of the outer ring to a top surface of the inner ring, and wherein the top surface of the legs tapers in a downstream direction from the top surface of the outer ring to the top surface of the inner ring.

24. The assembly of claim 23 wherein the top surface of the inner ring tapers from the top surface of the legs in a downstream direction.

25. The assembly of claim 1 wherein the axially downstream surface comprises a curved or tapered surface that extends from the shoulder to an outer peripheral edge of the disc.

26. The assembly of claim 1 wherein the shoulder spacing sits on a top surface of the inner ring.

27. The assembly of claim 1 including a shaft extending outwardly from the axially downstream surface of the disc wherein the shaft is fixed to the inner ring.

28. An assembly for limiting excess flow, the assembly comprising:
a seat having an inner ring, an outer ring having a top surface tapering in a downstream direction from the outer ring towards the inner ring, and a plurality of legs attaching the inner ring to the outer ring, and
a valve comprising a shaft fixed to the inner ring and a disc extending radially outwardly relative to the shaft, the disk having non-flat downstream surface when axially spaced from the seat, and wherein the non-flat downstream surface flexes into contact with the outer ring if the flow exceeds a limit around the disc, and wherein the valve includes a spacer that axially spaces the non-flat downstream surface from contact with the inner ring under all flow conditions.

29. The assembly of claim 28 wherein the spacer comprises a shoulder that transitions from one end of the shaft to the disc.

30. The assembly of claim 28 wherein the spacer sits on an upper surface of the inner ring.

31. The assembly of claim 28 wherein the non-flat surface is one of a tapered or curved surface.

32. The assembly of claim 31 wherein the disc includes a flat upstream surface when the flow does not exceed the limit, and wherein the flat upstream surface comprises a curved surface as outer edges of the disc flex to engage the top surface of the outer ring when the flow exceeds the limit.
